(19) United States
(12) Patent Application Publication
(10) Pub. No.: US 2023/0356847 A1
(43) Pub. Date: Nov. 9, 2023

(54) HEAT EXCHANGE DEVICE COMPRISING EXTERNAL PLATES HAVING AT LEAST ONE HOLLOW, AIR-CONDITIONING SYSTEM AND VEHICLE

(71) Applicant: LIEBHERR-AEROSPACE TOULOUSE SAS, Toulouse (FR)

(72) Inventors: Florian BONNIVARD, Toulouse (FR); Grégoire HANSS, Toulouse (FR); Antony SERIEYE, Toulouse (FR); Vincent LETELLIER, Toulouse (FR)

(73) Assignee: LIEBHERR-AEROSPACE TOULOUSE SAS, Toulouse (FR)

(21) Appl. No.: 18/143,336

(22) Filed: May 4, 2023

(30) Foreign Application Priority Data
May 4, 2022 (FR) FR2204230

(51) Int. Cl. B64D 13/08; F28D 9/00; F24F 13/30; F28F 3/04

(52) U.S. Cl. CPC B64D 13/08; F28D 9/0037; F24F 13/30; F28F 3/042

(57) ABSTRACT

A heat-exchange device includes a flow enclosure defined by two external plates, a first inlet and a first outlet for a first heat-transfer fluid, a second inlet and a second outlet for a second heat-transfer fluid, and an exchanger block with plates disposed in the flow enclosure so as to be in fluid communication with the inlets and outlets in order to permit the flow of the first fluid and of the second fluid into and through this exchanger block and the transfer of calories therebetween. Each external plate has at least one hollow. An air-conditioning system may include such device and an aircraft, in turn, can include such air-conditioning system.

### CROSS REFERENCE TO RELATED APPLICATIONS

This application claims priority under 35 U.S.C. § 119(a) to France patent application FR2204230 filed on May 4, 2022, the entire teachings of which are incorporated herein by reference.

### BACKGROUND OF THE INVENTION

### Field of the Invention

The present invention relates to a heat-exchange device, in particular a heat exchanger for an aircraft, comprising external plates having at least one hollow.

### Description of the Related Art

The heat exchangers with plates integrated in atmospheric vehicles are likely to be subjected to severe temperature gradients during their operating cycles. This is particularly the case e.g. for a heat exchanger intended to cool so-called bleed air at high pressure drawn from a propulsion engine of an aircraft or from an auxiliary power unit (APU).

When a heat exchanger begins to operate and to be supplied with bleed air, the temperature of the internal parts of the exchanger block (also called the “core”) increases more rapidly than the adjacent elements of the exchanger block and of the periphery thereof. This results in temperature gradients causing mechanical stresses and consequently possible deformations of the elements of the exchanger (e.g. rotation of the closure bars of the exchanger block). Such deformations can be so severe as to cause certain elements to rupture, being manifested by cracks or desoldering of some soldered parts. These phenomena lead to risks of leakage of fluid inside the exchanger, and even towards the outside thereof.

In order to overcome the consequences of the temperature gradients within heat-exchange devices of atmospheric vehicles, in particular aircraft, the increasing of the thicknesses of the elements of the exchanger block which are most susceptible to breaking and causing fluid leakages is known. Such a device, however, does not make it possible to satisfactorily increase the thermo-mechanical resistance of a heat-exchange device to temperature gradients. This solution contributes to a perceptible increase in the mass of the exchanger and is not desirable nor sufficiently effective in practice.

### BRIEF SUMMARY OF THE INVENTION

Embodiments of the invention disclosed herein aims to propose a heat-exchange device permitting these disadvantages to be overcome. To with, embodiments of the invention aim to provide a heat-exchange device having a very low level of sensitivity to temperature gradients, and in particular, to provide a heat-exchange device having excellent structural cohesion which is stable over time. Embodiments of the invention also aim to provide a heat exchange device with an excellent level of efficacy.

In order to achieve this, the invention relates to a heat-exchange device comprising:
a flow enclosure defined by at least two external plates,
a first inlet for a first heat-transfer fluid into the flow enclosure,
a first outlet for said first heat-transfer fluid out of the flow enclosure,
a second inlet for a second heat-transfer fluid into the flow enclosure,
a second outlet for said second heat-transfer fluid out of the flow enclosure,
an exchanger block with plates disposed in the flow enclosure so as to be in fluid communication with the inlets and outlets in order to permit the flow of the first heat-transfer fluid and of the second heat-transfer fluid into and through this exchanger block and the transfer of calories therebetween,
said exchanger block comprising a plurality of internal plates disposed substantially parallel with respect to each other,
characterized in that each external plate has at least one hollow.

Thus each hollow provided in said external plates makes it possible to facilitate the conduction of the heat from the inside of the exchanger block to the outside thereof via the regions of these hollows. A heat exchange device in accordance with the invention thus makes it possible to limit the temperature differences within such a heat-exchange device as well as the resulting stresses. This results in a greater mechanical resistance to the thermo-mechanical conditions. This thus makes it possible to avoid the rupture of certain pieces of the core of a heat-exchange device.

Throughout the text it will be understood that “external plate” means any plate having at least one main face which is not in contact with the first heat-transfer fluid and the second heat-transfer fluid flowing inside the exchanger block, in said flow enclosure.

Furthermore, it will be understood that “hollow” in each external plate means any at least partial recess in the thickness of said plate (e.g. a reduction in the thickness or a thinning) as well as any through opening, hollow or slot in the thickness of said external plate. Advantageously and in accordance with the invention, at least one internal plate of said exchanger block is placed next to each external plate so as to prevent any loss of the first heat-transfer fluid and/or of the second heat-transfer fluid through said hollow.

Advantageously and in accordance with the invention, each external plate has at least one through-opening (depending on its thickness).

Advantageously and in accordance with the invention, a heat-exchange device in accordance with the invention further comprises a plurality of protruding elements configured to be able to be in contact with said first heat-transfer fluid and/or said second heat-transfer fluid at the surface of a component of said heat-exchange device. In particular, advantageously and in accordance with the invention, each protruding element is formed by at least one material having a thermal conductivity and a volumetric heat capacity at least equal to the thermal conductivity and to the volumetric heat capacity of the material forming said internal plates of the exchanger block.

Advantageously and in accordance with the invention, a heat-exchange device in accordance with the invention further comprises at least one core band arranged to form at least one edge of the exchanger block, each core band having a plurality of protruding elements, said protruding elements being configured to be able to be in contact with at least one of said first heat-transfer fluid and second heat-transfer fluid (i.e. in contact with said first heat-transfer fluid and/or said second heat-transfer fluid). According to a particularly advantageous embodiment, said protruding elements are configured to be able to be in contact with said second heat-transfer fluid, either before said second inlet of the flow enclosure or after said second outlet of the flow enclosure. Thus each protruding element provided on each core band makes it possible to locally increase the temperature of the regions in which said protruding elements are provided.

Advantageously and in accordance with the invention, said protruding elements can also be provided on each external plate, said protruding elements being configured to be able to be in contact with said first heat-transfer fluid and/or said second heat-transfer fluid.

Advantageously and in accordance with the invention, each core band has at least one hollow. Thus, as an alternative to, or in combination with, the presence of protruding elements, a device comprises at least one core band arranged to form at least one edge of the exchanger block, each core band having at least one hollow.

Advantageously and in accordance with the invention, each core band is arranged to form at least one edge of the exchanger block, said edge extending in a direction orthogonal to said external plates.

The second heat-transfer fluid can correspond to the fluid which is at a temperature greater than the temperature of the first heat-transfer fluid or vice versa. Thus, advantageously and in accordance with the invention, the second heat-transfer fluid corresponds to the heat-transfer fluid which is at a temperature greater than the temperature of the first heat-transfer fluid. In other words, the first heat-transfer fluid can be designated “cold” fluid and the second heat-transfer fluid can be designated “hot” fluid.

Advantageously and in accordance with the invention, each core band extends between two longitudinal ends, said protruding elements being disposed on end portions of each core band. Said protruding elements are in the form of protuberances extending from a surface portion of an end portion of said core band and being able to be of varied geometric shapes. Said protruding elements can e.g. be in the form of fins, ribs, tongues, bosses, studs, teeth or even lugs.

Advantageously and in accordance with the invention, a heat-exchange device in accordance with the invention further comprises at least one box, referred to as supply box, forming a solid peripheral wall between an orifice and said flow enclosure, each supply box comprising an internal surface having a plurality of protruding elements, said protruding elements being configured to be able to be in contact with said first heat-transfer fluid and/or said second heat-transfer fluid.

Advantageously and in accordance with the invention, said protruding elements are at least partly in the form of ribs.

Advantageously and in accordance with the invention, said protruding elements are at least partially in the form of studs.

Advantageously and in accordance with the invention, said protruding elements are at least partly in the form of conduit portions.

Advantageously and in accordance with the invention, said protruding elements of a core band and said core band are formed as one piece. They can thus also be formed of the same material. The protruding elements can also be fixed by welding or soldering e.g. to said core band.

Advantageously and in accordance with the invention, an internal plate, referred to as insert plate, is disposed in contact with each external plate, between the internal plates of the exchanger block and said external plate. Thus the heat-transfer fluid flowing in the first or the last layer of the exchanger block in contact with said external plates does not escape through each hollow of said external plates.

The space between each of said internal plates of the exchanger block forming internal layers can be left free or at least partly provided with a flow guide. Advantageously and in accordance with the invention, a heat-exchange device in accordance with the invention further comprises at least one flow guide disposed between each internal plate of said exchanger block, each flow guide being adapted to form a plurality of channels which are substantially parallel to each other. Advantageously and in accordance with the invention, each internal layer is provided with at least one flow guide adapted to form a plurality of channels which are substantially parallel to each other.

Advantageously and in accordance with the invention, each flow guide is formed from a plurality of successive sections, each having a notched profile, so as to form guide walls and regions of surface contact with the plates. These are e.g. so-called offset flow guides, in which two successive sections are laterally offset so that the guide walls of a section located directly adjacent to another section are offset laterally (in a direction parallel to the external plates of the exchanger block) with respect to the guide walls thereof.

Each flow guide can be fixedly attached to the internal plates e.g. by soldering or by welding. Each flow guide can be fixedly attached to the external plates by a plurality of surface contacts. More particularly, the regions (external and internal) of contact of each flow guide are advantageously soldered to the internal faces of an internal plate and of the first or second internal plate (end plates).

The use of such flow guides between the internal plates of the exchanger block is optional but makes it possible to improve the efficacy of the heat exchanges. Internal plates with grooves can also be used.

Advantageously and in accordance with the invention, the heat-exchange device in accordance with the invention comprises:
a first passage, referred to as passage for the first heat-transfer fluid, permitting the flow of a stream of the first heat-transfer fluid in the flow enclosure between the first inlet and the first outlet, and
a second passage, referred to as passage for the second heat-transfer fluid, permitting the flow of a stream of the second heat-transfer fluid in the flow enclosure between the second inlet and the second outlet.

Advantageously and in accordance with the invention, said exchanger block is adapted to permit the flow of a first stream of heat-transfer fluid in said flow enclosure in a direction, referred to as main flow direction of the first fluid, between the first inlet and the first outlet.

A heat-exchange device in accordance with the invention can be cross flow or even counter current devices. Advantageously and in accordance with the invention, the course of the first stream of heat-transfer fluid and the course of the second stream of heat-transfer fluid within the exchanger block can each be substantially straight. Advantageously and in accordance with the invention, said heat-exchange device is a so-called cross flow device. The heat-exchange device in accordance with the invention is adapted to permit the flow of the second heat-transfer fluid in the passage for the second heat-transfer fluid, in a direction, referred to as flow direction of the second fluid, orthogonal to the main flow direction of the first fluid.

Of course, it is also possible to use any other type of exchanger block with plates, e.g. in which the stream of one and/or the other of the first or of the second heat-transfer fluid follows a U-shaped or even an S-shaped course.

Advantageously and in accordance with the invention, the first heat-transfer fluid and the second heat-transfer fluid flow in the spaces between the internal plates which are closed laterally by closing bars (or rods).

Advantageously and in accordance with the invention, the flow enclosure has a closed periphery which is sealed with respect to the heat-transfer fluids (at least in operation and without taking into account inlets and outlets for the first heat-transfer fluid and for the second heat-transfer fluid).

Advantageously and in accordance with the invention, each heat-transfer fluid can be in liquid or gaseous form. In particular, the state of the first heat-transfer fluid can be identical to, or different from, the state of the second heat-transfer fluid. Advantageously and in accordance with the invention, the first heat-transfer fluid and the second heat-transfer fluid are in gaseous form.

Advantageously and in accordance with the invention, the first inlet has a mouth for letting the first heat-transfer fluid into the flow enclosure. Advantageously and in accordance with the invention, the first outlet has a mouth for letting the first heat-transfer fluid out of the flow enclosure. In a particularly advantageous variant in accordance with the invention, each mouth has a single orifice forming an inlet or outlet, an opening towards the flow enclosure and/or towards the exchanger block with plates, and a solid peripheral wall between this orifice and this opening. Each orifice of each mouth can be connected to a conduit for letting in or evacuating the first heat-transfer fluid.

The heat-exchange device in accordance with the invention can be formed from at least one material chosen from metallic materials, composite materials, polymeric materials, ceramic materials, in particular graphite, glass . . . In particular, in one particularly advantageous embodiment of a heat-exchange device in accordance with the invention, the external and internal plates of the exchanger block are formed from a metallic material, in particular from at least one material chosen from the group formed by steels, copper, aluminum, metallic alloys (in particular super-alloys) and mixtures thereof. In particular, the core bands and their protruding elements are formed of at least one heat-conductive material, i.e. a material having sufficient heat conductance.

The invention relates to an air-conditioning system comprising at least one heat-exchange device in accordance with the invention. It may in particular be an exchanger without cross flow contact.

The invention relates to a vehicle, in particular an aircraft, comprising at least one air-conditioning system in accordance with the invention.

The invention also relates to a heat-exchange device, an air-conditioning system and a vehicle comprising at least one such air-conditioning system, which are characterized in combination by all or some of the features mentioned above or below.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. As well, in the drawings, for the sake of illustration and clarity, scales and proportions have not been strictly respected. Furthermore, identical, similar or analogous elements are designated by the same reference signs in all the figures. The embodiments illustrated herein are presently preferred, it being understood, however, that the invention is not limited to the precise arrangements and instrumentalities shown, wherein:

FIG. 1 is a schematic perspective view of a heat-exchange device in accordance with the invention,

FIG. 2 is a schematic perspective view of an exchanger block of a heat-exchange device in accordance with the invention,

FIG. 3 is a schematic perspective view of a portion of a heat-exchange device in accordance with the invention,

FIG. 4 is a schematic perspective view of a portion of a heat-exchange device in accordance with the invention,

FIG. 5 is schematic perspective view of a portion of a supply box of a heat-exchange device in accordance with the invention,

FIG. 6 is schematic perspective view of a portion of a supply box of a heat-exchange device in accordance with the invention,

FIG. 7 is a schematic perspective view of a core band of a heat-exchange device in accordance with a first embodiment of the invention,

FIG. 8 is a schematic perspective view of a detail of a core band of a heat-exchange device in accordance with the first embodiment of the invention,

FIG. 9 is a schematic perspective view of a detail of a core band of a heat-exchange device in accordance with a second embodiment of the invention.

### DETAILED DESCRIPTION OF THE INVENTION

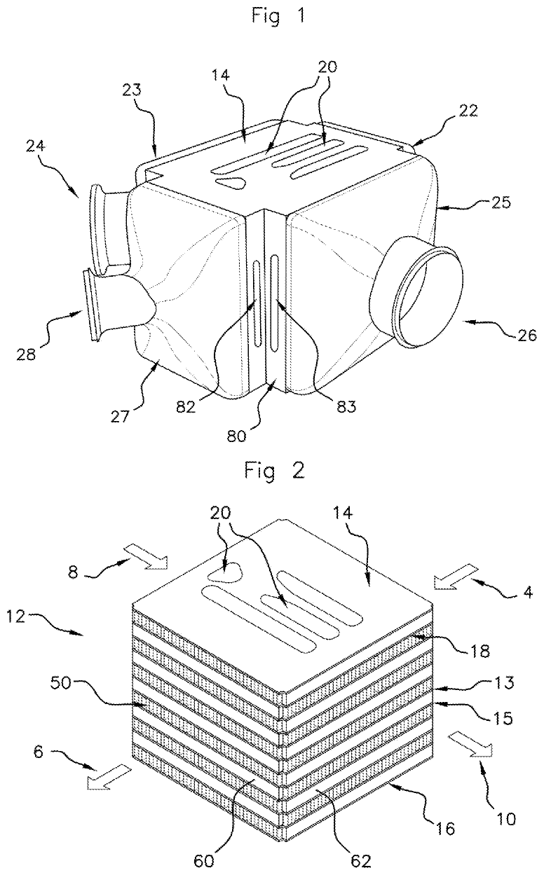

FIG. 1 schematically illustrates a heat-exchange device in accordance with a first embodiment of the invention.

FIG. 2 schematically illustrates an exchanger block 12 of the heat-exchange device in accordance with the first embodiment of the invention shown in FIG. 1.

A heat-exchange device of this type comprises a flow enclosure defined by two external plates 14 and 16, the exchanger block comprising internal plates 13, 15, 18 disposed substantially parallel to each other between the external plates 14, 16.

The heat-exchange device comprises a first inlet 4 and a first outlet 6 for a first heat-transfer fluid in the flow enclosure, as well as a second inlet 8 and a second outlet 10 for a second heat-transfer fluid in the flow enclosure.

The exchanger block 12 with plates thus makes possible the flow of the first heat-transfer fluid and second heat-transfer fluid in and through this exchanger block and the transfer of calories therebetween.

The first heat-transfer fluid, referred to as “cold” fluid, flows in regions of flow of the first heat-transfer fluid in a main flow direction of the first fluid between the first inlet 4 and the first outlet 6. The second heat-transfer fluid, referred to as “hot” fluid, flows in regions of flow of the second heat-transfer fluid, which are distinct from the regions of flow of the first heat-transfer fluid, between the second inlet 8 and the second outlet 10.

As shown by FIGS. 1 and 2, the external plate 14 has at least one hollow 20. In the illustrated embodiment, the external plate 14 has four hollows 20, three of which are oblong openings. Each hollow 20 is a through-opening localized within the thickness of the external plate. The openings (or holes) are provided so as not to extend to the borders and to the corners of the external plates. The openings are preferably localized within a substantially central region of each plate. As shown in FIG. 1, an internal plate of the exchanger block is placed next to each external plate 14, 16 (on the interior side of the exchanger block) preventing any leakage of the first heat-transfer fluid or of the second heat-transfer fluid through the openings. Each internal plate has a thickness smaller than the thickness of an external plate. Thus the heat from the inside of the exchanger block can be evacuated through each hollow 20 towards the outside of the exchanger block, each opening being provided in a central portion of each external plate, not comprising the borders of each external plate, no opening being provided directly in the proximity of the borders of the external plates. This makes it possible to limit the temperature differences within such a heat-exchange device as well as the resulting stresses.

The heat exchange device further comprises four core bands 80, each core band 80 being arranged to form an edge of the exchanger block. As shown in FIG. 1, the core band 80 comprises a hollow 82, 83 on each main face which can be seen from the outside of the heat-exchange device, in the manner of the hollows 20 provided in the external plate 14 of the exchanger block 12. Each hollow 82, 83 makes it possible to facilitate the conduction of the heat from the inside of the exchanger block to the outside thereof via the regions of these hollows through the thickness of the walls of the core band 80.

The heat-exchange device shown in FIG. 1 also comprises:
a first supply box 23 forming a solid peripheral wall between an orifice 24, forming an inlet mouth for the first heat-transfer fluid, and the first inlet 4 of the exchanger block 12,
a second supply box 26 forming a solid peripheral wall between an orifice 26, forming an outlet mouth for the first heat-transfer fluid, and the first outlet 6 of the exchanger block 12,
a third supply box 27 forming a solid peripheral wall between an orifice 28, forming an inlet mouth for the second heat-transfer fluid, and the second inlet 8 of the exchanger block 12,
a fourth supply box 22 forming a solid peripheral wall between an orifice, forming an outlet mouth for the second heat-transfer fluid, and the second outlet 10 of the exchanger block 12.

Furthermore, each orifice of each mouth can be connected to a conduit for letting in or evacuating the first heat-transfer fluid or the second heat-transfer fluid.

Protruding elements forming applied material additions can be provided on various surfaces of the components of the heat-exchange device so as to be in contact with the first heat-transfer fluid (preferably at its outlet, i.e. after it has been heated by the second heat-transfer fluid) or the second heat-transfer fluid (at the inlet and/or outlet of the flow enclosure of the exchanger block 12). Such protruding elements store the heat of the heat-transfer fluid with which they are in contact and promote the increase in the temperature of the adjacent or peripheral elements of the exchanger block, which also contributes to a reduction in the temperature gradients experienced by the exchanger block. Such protruding elements can e.g. be provided on the core bands and/or the inside of the supply boxes.

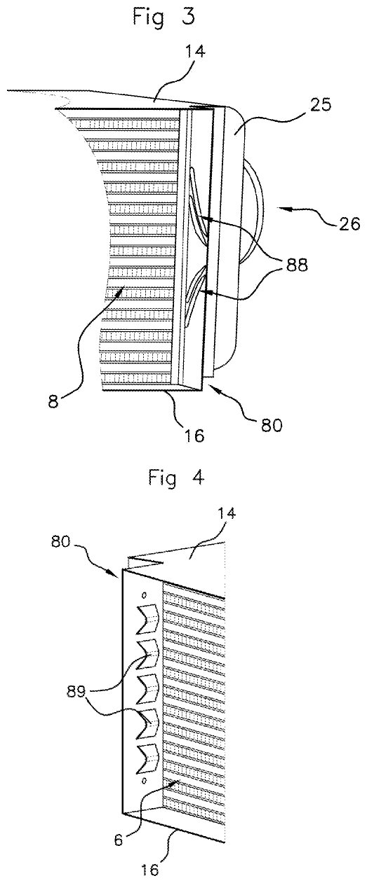

As shown in FIG. 3, the surface of the core band 80 located in contact with the second heat-transfer fluid (at the “hot” inlet 8) is provided with protruding elements 88 forming oblique ribs.

As shown in FIG. 4, the surface of the core band 80 located in contact with the first heat-transfer fluid (at the “cold” outlet 6) is provided with protruding elements 89 (in the form of inverted V's).

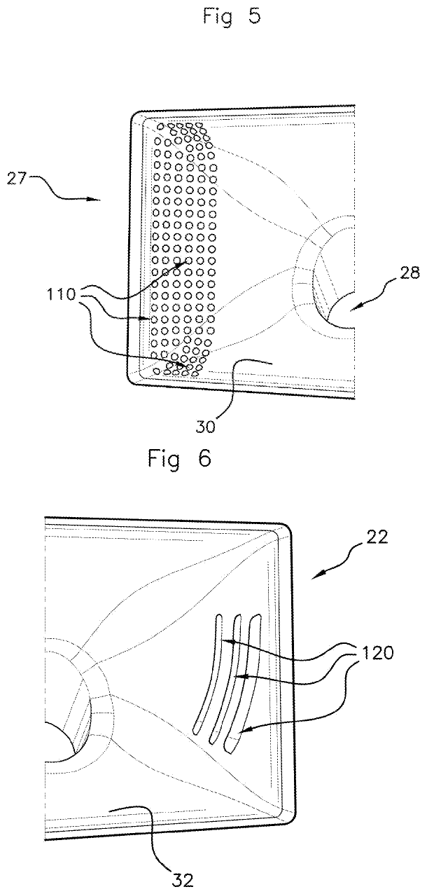

FIG. 5 shows the supply box 27 of the heat-exchange device, a portion of the internal surface 30 of which is provided with studs 110, being in this case in the form of six rows of studs 110 each comprising between 20 and 25 studs from one edge to the other of the supply box 27.

FIG. 6 shows the supply box 22 of the heat-exchange device, a portion of the internal surface 32 of which is provided with three ribs 120 which are substantially parallel to each other.

The protruding elements 88, 89 in contact with the first heat-transfer fluid (at its outlet 6) and of the second heat-transfer fluid (“hot” fluid) store the heat of this fluid and thus promote and accelerate the increase in the temperature of the adjacent or peripheral elements of the exchanger block.

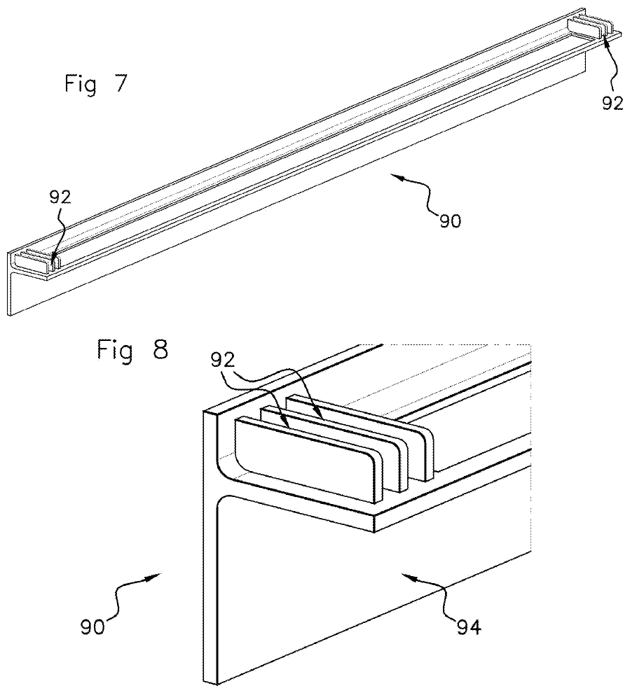

FIGS. 7 to 9 show two other embodiments of the core bands 90, 100. Each core band illustrated in FIGS. 7 to 9 has protruding elements 92, 102 configured to be able to be in contact with the first or the second heat-transfer fluid. This makes it possible for the protruding elements 92, 102 in contact with the second heat-transfer fluid (“hot” fluid) to store the heat of this fluid and thus promote and accelerate the increase in the temperature of the adjacent or peripheral elements of the exchanger block. The protruding elements 92, 102 thus make it possible to recover the heat by convection and to transfer it by conduction into the adjacent parts, the temperature of which is lower than the temperature of said protruding elements.

The protruding elements 92, 102 are disposed on end portions of each core band 90, 100, a planar region, with no such protruding elements, being provided between these two end portions.

In the embodiments illustrated in FIGS. 7 to 9, each core band 90, 100 is in the form of a straight profile having a T-shaped transverse cross-section (not symmetrical in this case). The protruding elements 92, 102 can be disposed on the same surface of each T-shaped core band 90, 100. In the embodiments illustrated in FIGS. 7 to 9, each core band 90, 100 has a free wall 94, 104, substantially orthogonal to the surface provided with protruding elements 92, 102, one face of which can be fixed to an edge of the exchanger block, the opposing face of the wall 94, 104 being able to be used to attach thereto an outlet and/or supply box of the second heat-transfer fluid.

The protruding elements can be of various forms, e.g. of the fin, rib, tongue, boss, stud, tooth or even spike type.

In a first embodiment variant of a heat-exchange device in accordance with the invention illustrated in FIGS. 7 and 8, the protruding elements are in the form of ribs 92. For example, three ribs 92 are provided in this case at each end of each core band 90 in the embodiment variant illustrated in FIGS. 7 and 8.

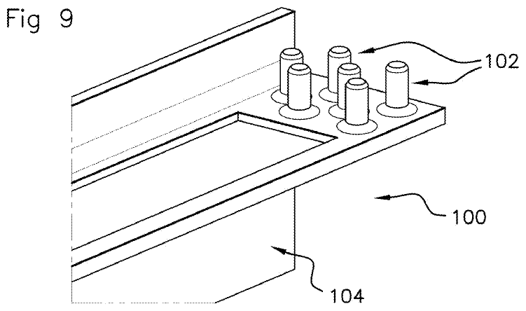

In a second embodiment variant of a heat-exchange device in accordance with the invention illustrated in FIG. 9, the protruding elements are in the form of studs 102. For example, six studs 102 are provided in this case at each end of each core band 100 in the embodiment variant illustrated in FIG. 9.

In a third embodiment variant of a heat-exchange device in accordance with the invention (not illustrated), the protruding elements are in the form of conduit portions or flow guides.

The protruding elements 92, 102 of a core band 90, 100 can be molded simultaneously with the core band during manufacture thereof, or even welded or soldered on the surface thereof so as to form only a single piece (of a distinct or non-distinct material).

On the other hand, in the illustrated embodiment, each internal layer of the exchanger block 12 is provided with a flow guide 50 forming a plurality of channels which are substantially parallel with each other. The spaces between the internal plates 13, 15, 18 are formed laterally by closure bars 60, 62. The internal plates 13, 15, 18 are disposed parallel to each other and parallel to the external plates 2.

In the variants illustrated in FIGS. 1 to 9, the course of the first and of the second stream of heat-transfer fluid within the exchanger block is substantially straight (not taking into consideration possible sinuosities in the presence of some flow guides). Of course, it is also possible to use any other type of exchanger block with plates, e.g. in which the stream of one and/or the other of the first or of the second heat-transfer fluid follows a U-shaped or even an S-shaped course.

In the illustrated embodiments, flow guides 50 extend through all the internal layers of the exchanger block 12.

A heat-exchange device in accordance with the invention thus effectively makes it possible to effectively limit the temperature gradients likely to damage the exchanger block.

The invention is not limited to the embodiments described. In particular, there is nothing to prevent the provision of protruding elements of different shapes on each core band.

Of note, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, and/or “including,” when used in this specification, specify the presence of stated features, integers, steps, operations, elements, and/or components, but do not preclude the presence or addition of one or more other features, integers, steps, operations, elements, components, and/or groups thereof.

As well, the corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. A heat-exchange device comprising:
a flow enclosure defined by at least two external plates,
a first inlet for a first heat-transfer fluid into the flow enclosure,
a first outlet for said first heat-transfer fluid out of the flow enclosure,
a second inlet for a second heat-transfer fluid into the flow enclosure,
a second outlet for said second heat-transfer fluid out of the flow enclosure,
an exchanger block with plates disposed in the flow enclosure so as to be in fluid communication with the inlets and the outlets in order to permit the flow of the first heat-transfer fluid and of the second heat-transfer fluid into and through this exchanger block and the transfer of calories therebetween,
said exchanger block comprising a plurality of internal plates disposed substantially parallel with respect to each other, characterized in that each external plate has at least one hollow.

2. The device as claimed in claim 1, further comprising at least one core band arranged to form at least one edge of the exchanger block, each core band having a plurality of protruding elements configured to be able to be in contact with at least one of said first heat-transfer fluid and second heat-transfer fluid.

3. The device as claimed in claim 1, wherein the second heat-transfer fluid corresponds to the heat-transfer fluid which is at a temperature greater than the temperature of said first heat-transfer fluid.

4. The device as claimed in claim 1, further comprising at least one box, referred to as supply box, forming a solid peripheral wall between an orifice and said flow enclosure, each supply box comprising an internal surface having a plurality of protruding elements, said protruding elements being configured to be able to be in contact with said first heat-transfer fluid and/or said second heat-transfer fluid.

5. The device as claimed in claim 2, wherein said protruding elements are at least partially in the form of ribs.

6. The device as claimed in claim 2, wherein said protruding elements are at least partially in the form of studs.

7. The device as claimed in claim 2, wherein said protruding elements of a core band and said core band are formed as one piece.

8. The device as claimed in claim 1, further comprising at least one core band arranged to form at least one edge of the exchanger block, each core band having at least one hollow.

9. The device as claimed in claim 1, further comprising at least one flow guide disposed between each internal plate of said exchanger block, each flow guide being adapted to form a plurality of channels which are substantially parallel to each other.

10. An air-conditioning system comprising:
at least one heat-exchange device comprising:
a flow enclosure defined by at least two external plates,
a first inlet for a first heat-transfer fluid into the flow enclosure,
a first outlet for said first heat-transfer fluid out of the flow enclosure,
a second inlet for a second heat-transfer fluid into the flow enclosure,
a second outlet for said second heat-transfer fluid out of the flow enclosure,
an exchanger block with plates disposed in the flow enclosure so as to be in fluid communication with the inlets and the outlets in order to permit the flow of the first heat-transfer fluid and of the second heat-transfer fluid into and through this exchanger block and the transfer of calories therebetween,
said exchanger block comprising a plurality of internal plates disposed substantially parallel with respect to each other, characterized in that each external plate has at least one hollow.

11. An aircraft comprising:
an air-conditioning system, the air-conditioning system comprising at least one heat-exchange device comprising:
a flow enclosure defined by at least two external plates,
a first inlet for a first heat-transfer fluid into the flow enclosure,
a first outlet for said first heat-transfer fluid out of the flow enclosure,
a second inlet for a second heat-transfer fluid into the flow enclosure,
a second outlet for said second heat-transfer fluid out of the flow enclosure,
an exchanger block with plates disposed in the flow enclosure so as to be in fluid communication with the inlets and the outlets in order to permit the flow of the first heat-transfer fluid and of the second heat-transfer fluid into and through this exchanger block and the transfer of calories therebetween,
said exchanger block comprising a plurality of internal plates disposed substantially parallel with respect to each other, characterized in that each external plate has at least one hollow.
